(19) United States
(12) Patent Application Publication
(10) Pub. No.: US 2004/0186798 A1
(43) Pub. Date: Sep. 23, 2004

(54) System and method for managing telecommunications resources

(76) Inventors: Bird D. Blitch, Atlanta, GA (US); John A. Monin, Atlanta, GA (US); Joseph D. Carr, Atlanta, GA (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 10/784,135

(22) Filed: Feb. 20, 2004

Related U.S. Application Data
(60) Provisional application No. 60/448,662, filed on Feb. 20, 2003.

(51) Int. Cl. G06F 17/60

(52) U.S. Cl. 705/29; 705/28

(57) ABSTRACT

The present invention provides systems and methods for managing telecommunications resources. Exemplary embodiments of the present invention track inventory for telecommunications resources and modify the inventory when inventory is added, subtracted, or modified. The present invention may also maintain contract data representative of the telecommunications contracts governing the telecommunications resources. A billing processing unit may be used to maintain billing data for bills received under the telecommunications contracts. A processing unit may be used to compare the bills to existing inventory and the contracts to verify the accuracy of the bills.

### CLAIM OF PRIORITY

This application claims the benefit of co-pending U.S. Provisional patent application entitled “System and Method for Managing Telecommunication Resources” filed on Feb. 20, 2003 and assigned serial No. 60/448,662, which is incorporated by reference in its entirety as if fully set forth herein.

### TECHNICAL FIELD

This invention relates generally to computer systems, and more particularly to a system and method for managing telecommunications resources.

### BACKGROUND OF THE INVENTION

As communications companies have improved their equipment and services offerings, businesses have grown to rely more and more on communications resources. For most companies today, communications services and equipment account for a large percentage of the company's annual budget. In fact, an average company spends $3,000-5000 per year per employee on voice, data, and internet services.

Often, the burden of reviewing bills and maintaining communications equipment falls on the information technology (IT) department of a company. When the IT department is unable to efficiently monitor the use of the equipment and the bills for the equipment and services, the company may lose money due to the overpayment of bills and the payment of invoices on equipment that is no longer being used.

As companies expand, communications costs can spin out of control, especially as the number of business locations increase and the communications invoices become increasingly complex. Companies typically overspend on communication services by 20% a year by: (a) paying for unused services or services they do not need; (b) paying bills that are incorrect (80% of all communications invoices have errors); (c) lacking full and complete visibility into the spending on communications; and (d) not paying bills on time and incurring late charges.

Errors in billing may occur when (a) invoices do not comply with contracted rates, (b) invoices are received for resources not currently in service, (c) invoices are received for equipment previously used by employees who are no longer with the company.

Some companies have attempted to create systems to satisfy this need, but each system fails to provide an integrated solution to monitor and update a companies telecom usage and bills. U.S. patent publication 2002/0082991 to Friedman et al. describes one such system. Friedman describes a system that compares a company's telecom inventory against received bills, but it does not describe a system that handles new service requests and thereby keeps the inventory updated. If inventory is not updated when resources are added, subtracted, or modified, the inventory records may not remain accurate. If inventory is not accurate, bill reconciliation will not operate accurately.

Therefore, there is a need in the art for a system and method for monitoring the inventory of communications resources.

Further, there is a need in the art for a system and method for modifying the inventory when resources are added, subtracted, or modified.

Further, there is a need in the art for a system and method for identifying incorrect invoices for communications resources and services.

Further, there is a need in the art for a system and method for eliminating unnecessary communications resources.

### SUMMARY OF THE INVENTION

The present invention overcomes these and other problems in the art by providing a system and method for managing communications resources. In an exemplary embodiment of the present invention, the system stores inventory data regarding communications resources owned or used by a company. Additionally, the system updates the inventory data when resources are added, subtracted, or modified. Further, the system may monitor each employee and identify which communications resources are used by each employee.

In an exemplary embodiment of the present invention, the system compares communications invoices with communications resource inventory and communications contracts to identify errors in billing and to ensure companies only pay for services they are using and at the agreed upon contract rates.

The system is also able to review invoices to identify potential erroneous charges such as slamming/cramming and variances in charges at the line item level. When bill discrepancies are detected, the company can track the discrepancy and notify the communications service provider about the inaccuracy in the invoice.

Other objects, features, and advantages of the present invention will become apparent upon reading the following detailed description of the embodiments of the invention, when taken in conjunction with the accompanying drawings, and appended claims.

### BRIEF DESCRIPTION OF THE DRAWINGS

FIG. 1 is a system diagram that illustrates an exemplary environment suitable for implementing various embodiments of the present invention.

FIG. 2 is a block diagram that illustrates an exemplary embodiment of a telecommunications management system in accordance with an exemplary embodiment of the present invention.

FIG. 3 is a flow diagram illustrating a bill paying procedure in accordance with an exemplary embodiment of the present invention.

FIG. 4 is a flow diagram illustrating a service modification procedure in accordance with an exemplary embodiment of the present invention.

### DETAILED DESCRIPTION

Referring now to the drawings, in which like numerals refer to like parts throughout the several views, exemplary embodiments of the present invention are described. Throughout the detailed description, reference will be made to the operation of the present invention when embodied within a computing device. Computing devices may include, but are not limited to, personal computers, mainframe computers, servers, and any other device capable of executing the software associated with the present invention. Additionally, while the detailed description focuses primarily on the present invention embodied in a telecommunications management system 200, the invention may be applied to any form of resource management system 200 and the telecommunications management example is intended as an exemplary embodiment and in no way limits the application of the invention. However, it should be understood that the features and aspects of the present invention can be ported into a variety of systems and system configurations and any examples provided within this description are for illustrative purposes only.

In general, the present invention can be described as a system and method for resource management that can be accessed and exploited from a single platform to facilitate operational needs for a user or company.

Exemplary Environment

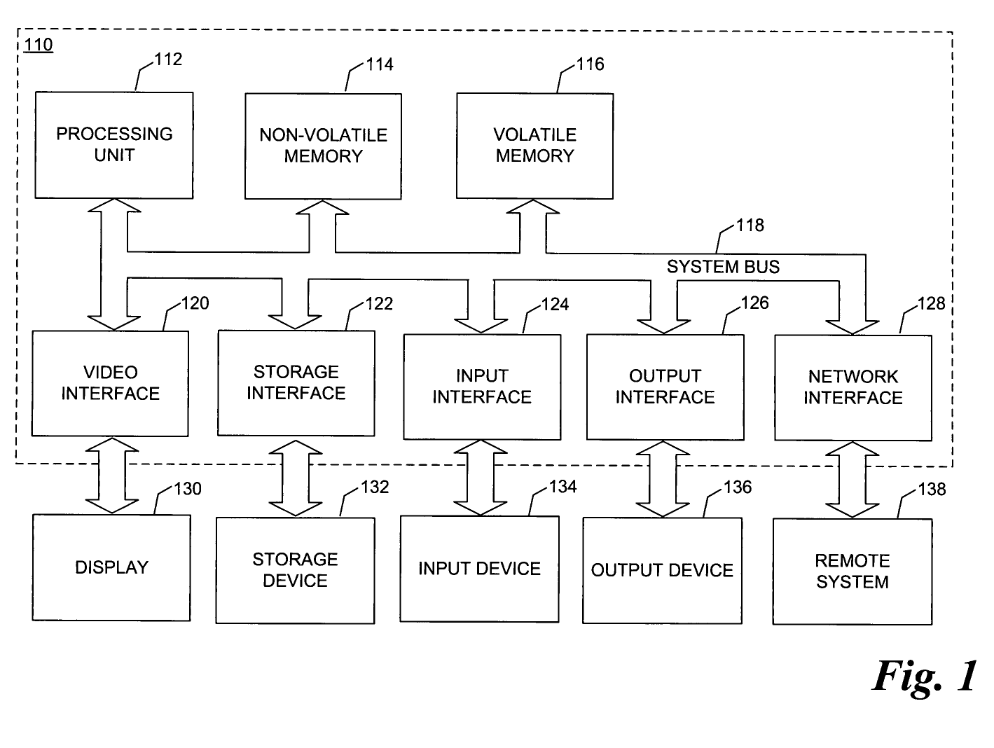

FIG. 1 is a system diagram that illustrates an exemplary environment suitable for implementing various embodiments of the present invention. FIG. 1 and the following discussion provide a general overview of a platform onto which the invention, or portions thereof, may be integrated, implemented and/or executed. Although in the context of the exemplary environment the invention will be described as consisting of instructions within a software program being executed by a processing unit, those skilled in the art will understand that portions of the invention, or the entire invention itself may also be implemented by using hardware components, state machines, or a combination of any of these techniques. In addition, a software program implementing an embodiment of the invention may run as a stand-alone program or as a software module, routine, or function call, operating in conjunction with an operating system, another program, system call, interrupt routine, library routine, or the like. The term program module will be used to refer to software programs, routines, functions, macros, data, data structures, or any set of machine readable instructions or object codes, or software instructions that can be compiled into such, and executed by a processing unit.

Those skilled in the art will appreciate that the system illustrated in FIG. 1 may take on many forms and may be directed towards performing a variety of functions. Generally, the system illustrated in FIG. 1 may be any system that includes a computer processor. Examples of such forms and functions include, but are not limited to, personal computers, hand-held devices such a personal data assistants, note-book computers, lap-top computers, mainframe computers, servers and a variety of other applications, each of which may serve as an exemplary environment for embodiments of the present invention.

The exemplary system illustrated in FIG. 1 includes a computing device 110 that is made up of various components including, but not limited to a processing unit 112, non-volatile memory 114, volatile memory 116, and a system bus 118 that couples the non-volatile memory 114 and volatile memory 116 to the processing unit 112. The non-volatile memory 114 may include a variety of memory types including, but not limited to, read only memory (ROM), electronically erasable read only memory (EEROM), electronically erasable and programmable read only memory (EEPROM), electronically programmable read only memory (EPROM), electronically alterable read only memory (EAROM), FLASH memory, bubble memory, and battery backed random access memory (RAM). The non-volatile memory 114 provides storage for power-on and reset routines (bootstrap routines) that are invoked upon applying power or resetting the computing device 110. In some configurations the non-volatile memory 114 provides the basic input/output system (BIOS) routines that are utilized to perform the transfer of information between elements within the various components of the computing device 110.

The volatile memory 116 may include, but is not limited to, a variety of memory types and devices including, but not limited to, random access memory (RAM), dynamic random access memory (DRAM), FLASH memory, EEPROM, bubble memory, registers, or the like. The volatile memory 116 provides temporary storage for routines, modules, functions, macros, data etc. that are being or may be executed by, or are being accessed or modified by the processing unit 112. In general, the distinction between non-volatile memory 114 and volatile memory 116 is that when power is removed from the computing device 110 and then reapplied, the contents of the non-volatile memory 114 remain in tact, whereas the contents of the volatile memory 116 are lost, corrupted, or erased.

The computing device 110 may access one or more external display devices 130 such as a CRT monitor, LCD panel, LED panel, electro-luminescent panel, or other display device, for the purpose of providing information or computing results to a user. In some embodiments, the external display device 130 may actually be incorporated into the product itself. The processing unit 112 interfaces to each display device 130 through a video interface 120 coupled to the processing unit 110 over the system bus 118.

The computing device 110 may send output information, in addition to the display 130, to one or more output devices 136 such as a speaker, modem, printer, plotter, facsimile machine, RF or infrared transmitter, computer or any other of a variety of devices that can be controlled by the computing device 110. The processing unit 112 interfaces to each output device 136 through an output interface 126 coupled to the processing unit 112 over the system bus 118. The output interface 126 may include one or more of a variety of interfaces, including but not limited to, cable modems, DLS, T1, V series modems, an RS-232 serial port interface or other serial port interface, a parallel port interface, a universal serial bus (USB), a general purpose interface bus (GPIB), an optical interface such as infrared or IRDA, an RF or wireless interface such as Bluetooth, or other interface.

The computing device 110 may receive input or commands from one or more input devices 134 such as a keyboard, pointing device, mouse, modem, RF or infrared receiver, microphone, joystick, track ball, light pen, game pad, scanner, camera, computer or the like. The processing unit 112 interfaces to each input device 134 through an input interface 124 coupled to the processing unit 112 over the system bus 118. The input interface 124 may include one or more of a variety of interfaces, including but not limited to, cable modems, DSL, T1, V series modems, an RS-232 serial port interface or other serial port interface, a parallel port interface, a universal serial bus (USB), a general purpose interface bus (GPIB), an optical interface such as infrared or IrDA, an RF or wireless interface such as Bluetooth, or other interface.

It will be appreciated that program modules implementing various embodiments of the present invention may be stored in the non-volatile memory 114, the volatile memory 116, or in a remote memory storage device accessible through the output interface 126 and the input interface 124. The program modules may include an operating system, application programs, other program modules, and program data. The processing unit 112 may access various portions of the program modules in response to the various instructions contained therein, as well as under the direction of events occurring or being received over the input interface 124.

Resource Management System

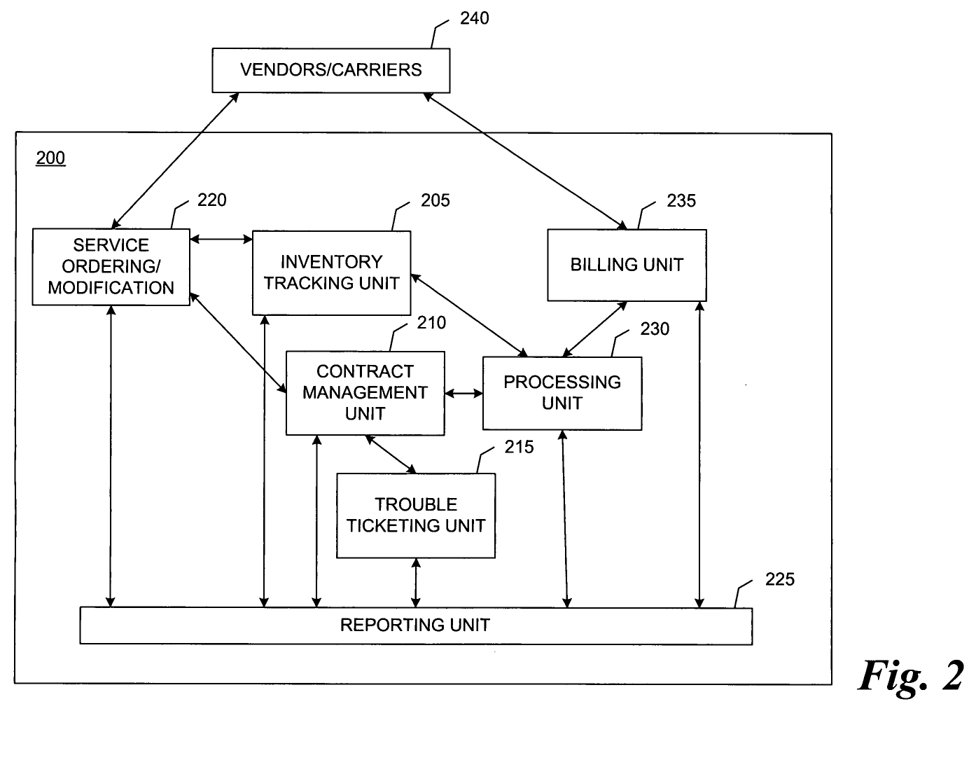

FIG. 2 is a block diagram illustrating an exemplary embodiment of a telecommunications management system 200 in accordance with the present invention. The telecommunications management system 200 may include, but is not limited to, an inventory tracking unit 205, a contract management unit 210, a telecom trouble ticketing unit 215, a service ordering/modification unit 220, a reporting unit 225, a processing unit 230, and a billing unit 235. Each unit may be implemented in a software module, in hardware, or other alternatives known to those skilled in the art.

In an exemplary embodiment of the present invention, an inventory tracking unit 205 may keep up to date records of an organization's telecommunications inventory. The inventory tracking unit may be in communication with the service ordering/modification unit 220 for updating the inventory as changes are made. Throughout the present description, the service ordering/modification unit 220 may also be referred to as the inventory modification unit 220.

A typical organization may operate in more than one facility and may be subdivided into multiple business units or other subdivisions. Accordingly, inventory may be maintained and allocated to a specified facility, business unit, and/or employee associated with the organization. Often, a user may wish to categorize fixed resources, such as landline telephones and fax machines, by the facility at which it is located and categorize mobile resources, such as cell phones, by the user to which it is assigned. Alternatively, the system 200 may allow devices to be identified by both a facility and an individual. The inventory tracking unit may be set up to provide separate information about each facility, location, or user (user wallet) and identify all resources associated with that facility, location, or user. Using this feature, a user may monitor and identify information such as, but not limited to, contracts due for expiration in the near future and trouble tickets and orders that are pending for a particular location or user.

Telecommunications resources may also be identified by the type of resource. For example, and not limitation, typical resources may include voice, video, data, internet, and any other available telecommunications resources. Additionally, each resource type may be further subdivided into subcategories. For example, and not limitation, the voice resource category may include local switched phone service, cell phone service, long distance phone service, calling cards, and other voice resources.

When viewing inventory data for a given facility, a user may wish to see all of the resources assigned to the facility. For example, these resources may include, but are not limited to, local phone service, long distance phone service, data services, dedicated internet services, circuit management resources, and other resources available at a given facility. Since other resources, such as mobile phones and calling cards, are more likely to be assigned to an individual, a user may wish to list such individual resources separately from the facility inventory or include the inventory assigned to users that are based out of the facility. In an exemplary embodiment of the present invention, a user wallet may be created to identify each resource assigned to a particular user or employee. The user wallet may be used to identify resources used by a user and may simplify the process of adding or canceling services when a user joins or leaves the organization.

In an exemplary embodiment of the present invention, an inventory database is part of the inventory tracking unit 205 and stores inventory data. The inventory database may be organized in accordance with user preferences. Typically, equipment may be organized by class (voice or data), then by facility, then by room (location within a facility), and then by type (key, router, pbx, or other type). Reports and screen displays may present the inventory for a particular category upon user request. From within inventory displays, a particular inventory item may be selected and details about the inventory item may be displayed.

The inventory tracking unit 205 may be used to track many types of telecommunications resources including, but not limited to, local switched voice telephone services, local dedicated voice telephone services, long distance switched voice telephone services, long distance dedicated telephone services, calling cards, frame relay data services, ATM data services, private line data services, dedicated internet services, DSL internet services, wireless telephone services, PDAs, pagers, CPE services, any other desired telecommunications services, and any equipment associated with any of the telecommunications services.

Typically, each user may have one or more services assigned to him or her. While each of these items may be assigned from the inventory tracking system interface 205, it may be more convenient to set up a user's equipment and services at one time or to manage the user's equipment and services together, separate from the main inventory interface 205. Accordingly, in an exemplary embodiment of the present invention, a user wallet may be set up identifying any equipment or services assigned, or to be assigned, to a particular user or employee. The user wallet feature may be useful when an employee joins or leaves the organization. In such instances all of the employee's equipment and services may be added or deleted together through the integrated service ordering/modification unit 220. In an exemplary embodiment of the present invention, when a user leaves the organization, old equipment may either be retired or offered to other users who have requested such equipment.

Services may be added, subtracted, or modified from within the service ordering/modification unit 220. Any additions, subtractions, or modifications entered through the ordering/modification unit 220 may be automatically communicated to the inventory tracking unit 205 to maintain accurate inventory records upon confirmation that the installation is complete. The ordering/modification unit 220 may place orders for additions, subtractions, or modification in a variety of ways. For example, and not limitation, the system 200 may be in communication with service providers 240 to automatically place orders for changes, the system 200 may send an electronic message requesting a service change, the system 200 may instruct an administrator to manually place an order, the system 200 may generate a printed order for submission to a vendor, or any other method of generating an order.

When adding multiple services or devices having the same features, the system 200 allows them to be entered together. For example, and not limitation, if multiple telephone numbers are added having the same features, they may be added together. If the numbers are consecutive within a range, the range may be identified and all numbers in the range may be setup together.

In an exemplary embodiment of the present invention, it is generally preferable to enter all service changes through the service ordering/modification unit 220. This ensures that the inventory is maintained with up to date data as the system 200 reconciles service changes with inventory records. Alternatively, the system 200 may allow a user to directly modify inventory data without using the service ordering/modification unit 220. Such entry may be preferable when small changes, such as typos, need to be corrected, or if existing accounts are being moved into the system 200. Generally however, it is preferable to enter most inventory changes through the service ordering/modification unit 220 to ensure the integrity of the inventory database. Users may track existing orders from the service ordering/modification unit 220.

In an exemplary embodiment of the present invention, a user may view contract details of a given resource through the system 200 and may make changes to the service, cancel the service, or add services, through the system interface. When such changes are made through the system 200, the inventory system 205 is updated and records are maintained accurately.

In an exemplary embodiment of the present invention, a contract management unit 210 maintains the contracts of each telecommunications service. Typically, each basic service at a location is associated with one contract. Each contract, however, may be used for many services at many different locations. For example, and not limitation, a carrier may handle internet and local phone service for all facilities in a city or region under a single contract. The system 200 maintains links between resources and contracts so that the processing unit 230 may reconcile bills in the billing unit 235 with inventory and the inventory's respective contracts.

In an exemplary embodiment of the present invention, contracts may be viewed in a plurality of ways. A basic location-view inventory user interface display will typically link the user to the contract used for a given piece of equipment or associated service. Typically, the system 200 provides a details page outlining the specifications for each resource. The details page may also have a link to the contract. Additionally, each contract may be viewed using the contract management unit 210.

In various embodiments of the present invention, contracts may be viewed electronically in full, or in summary form showing the contract attributes. The electronic version of the contract may be viewed in PDF format or any other desired electronic format. The summary form may include, but is not limited to, the contract price, the contract duration, key terms, included equipment and/or services, or any other desired contract details.

Within the contract management unit 210, expiring contracts may be identified prior to actual expiration. For example, and not limitation, a user may view all contracts expiring within the next 90 days. A particular contract may continue to appear, even if it is expired, until it is deleted by an administrator or is modified to identify a later expiration date.

The contract management unit 210 uses a contract management database to store contracts and contract details. New contracts may be added to the contract management database manually or electronically. For manual entry, the system 200 may prompt a user to enter information pertaining to contract information. Such contract information may include, but is not limited to, rates, duration, equipment covered, and any other desired contract information. This information may also be linked to an electronic copy of the contract. Alternatively, electronic details of the contract may be provided to the system 200 representative of the contract terms.

The system 200 may allow modification of inventory directly without use of the service ordering/modification unit 220. However, directly editing equipment or service information in the system 200 without confirming that the changes were actually made in physical inventory may make effectively managing inventory and costs difficult. Accordingly, it may be preferable to prevent inventory modification except through the service order/modification unit 220. The system 200 may provide additional accountability and consistency for changes to inventory while working within company procedures. For example, and not limitation, the company may set up users as administrators or non-administrator employees. Certain requests may require administrator approval and the system 200 may be set up to obtain administrator approval before completing a user request. When an order is placed by a user, an administrator may be notified that his or her assistance is necessary to order changes for equipment or services. He or she will then have the ability to create a specific order based on the specific services and contracts necessary to resolve the request. Alternatively, the administrator may deny the user's request. Additionally, the system 200 may be customized to inform other managers, administrators, contract negotiators, and/or carrier representatives as the order proceeds, thus keeping important parties informed.

Additionally, in an exemplary embodiment of the present invention, the system 200 may be set up to require a number of sequential steps to be followed for an order to be completed. For example, and not limitation, this may include steps for approval in the organization, for confirmation with a carrier, or for the transfer of a device to another user. Throughout the process, as more information is received, the order may increase in detail to include such specifics as phone numbers, serial numbers, or other details. Upon completion, an administrator may complete the order and transfer the affected services and/or items into inventory, making them accessible from the inventory tracking unit 205.

In an exemplary embodiment of the present invention, orders may be entered as user wallet orders, service orders, or other order types. When an employee is newly hired, or leaves the company, or needs a change in service regarding new or existing items in his or her user wallet, it may be preferable to place the order as a wallet order. Typically, this may be performed from a user detail page. When approved by an administrator, this type of order may allow service requests to be made and resolved for a particular user. An administrator may be able to choose details to change on each ordered item as well as complete user changes such as deleting a user.

If a service is added, deleted, or modified for a location or facility, a service order may be opened for an individual service. Location details, such as phone service, internet service, or data services may be modified through a service order. Additionally, if the company wishes to purchase a block of similar wallet items (such as cell phones, pagers, PDAs, or the like) to assign to users, the block may be requested through a service order.

In the case of both wallet orders and service orders, the order system may lead an administrator through the process of verifying the request before adding the details to the inventory, assuring that an up-to-date, usable inventory of telecommunication services and assets.

Typically, all users who are connected to an order are able to view the details of the order as it progresses toward completion. Alternatively, access to the order progress may be limited as desired.

An administrator who receives an order request may manage the order through several stages in order to complete the order. Through this process, other affected users may monitor the process. The different stages of an exemplary order process are explained as follows:

Order Request Form

When a user desires a new service or item of equipment, he or she may order it either from within a specific service or from a particular user's wallet. The order request may, but is not limited to, store the location information, request a due date, provide an order name, and provide an order description. The user may also choose an administrator to handle the order. Typically, the administrator will be contacted concerning the request. Such contact may be performed using email, other electronic message, or any other desired medium of contact.

Order Detail (Before Acceptance)

When a user submits an order request, it may appear in a “Pending Orders” window within the order management system 220. At this point, the order details screen consists of the “Order Step” window with details from the order request, a status indicator showing that the order as been submitted, and buttons allowing the administrator to accept or decline the order.

Order Detail (After Acceptance)

Once accepted, the order detail window may expand to display additional information for each order, including any order sequence, discussion notes, and panels for any ordered sub-service or associated CPE equipment and circuits. This screen may convey discrete details concerning what was described in the description of the order request.

Order Setup

When a user submits an order, order details may be contained in a descriptive paragraph. To apply those details to the specific services that an administrator identifies as needing to be ordered, the administrator may utilize an order setup wizard. The order setup wizard may allow the administrator to select the specific services for the order, identify the order sequence and provide contact information (such as email addresses).

Locating an Order

Each order may be given an “order name”-a short description or subject summarizing the order-by the user filing it. The order may then be selected later to view details on the order. Typically, pending order may be accessed through a “Pending Orders” panel. While administrators typically have access to view all orders, only the user who filed the order (along with any other users the administrator has associated with it) may be able to see the order details.

Order Details

Once an order is selected, the system 200 may display an order details screen. This screen may contain information for an order, which may include, but is not limited to, associated contacts, currently completed and yet-to-be completed steps, and service changes with associated contracts.

As the order progresses, the administrator may update each service panel to reflect changes as received from the affected carriers. When a service order has been finished, that particular panel may be visually tagged as “completed” and the changes the administrator had made in that order may now show up in the inventory tracking unit 105.

When a user initiates an order, he or she may choose an administrator to whom the order should be directed. The chosen administrator may then be notified regarding the order.

After receiving notification, the administrator may access the order. An order details screen typically presents two options to administrators: the choice to proceed, or the choice to decline the order. To assist in this decision, the initial order details screen may provide, but is not limited to, the information that was entered by the user filing the order, along with location information, a due date, and a description of the order.

The administrator may chose to decline the order if he or she does not wish to allow the order to continue. Typically, the administrator may be prompted to explain the rejection. This rejection may be provided to the requesting user. The order may also be flagged as “declined” and moved to a “Closed Orders” display.

If the administrator would like to continue with an order, the order may be approved and flagged as “in process.” Thus, work may commence on the order. If a user does not know what services should be ordered, he or she may type a contextual description of a request and leave the specific order decisions to the administrators.

Services and Equipment Setup

After the basic order details are entered and/or approved, the administrator may select the specific types of services that will be ordered within this transaction. Each service type is preferably associated with specific contracts and equipment.

Managing Order Contacts

Since an order may contain any number of services, using any amount of equipment, calling on possibly many different members of an organization and the organization's vendors, it may be helpful to keep many, or all, of the affected people in a contact list for the order. The system 200 may allow a user or administrator to create a contact list to keep each affect user informed of the order as it is processed.

Managing the Order Sequence

The system 200 may allow administrators to sign off for each stage of an order, letting others know what to expect as far as the order steps go, and filling them in on how much has been completed at any given point. An order sequence consists of a series of “steps”, each of which may include, but is not limited to, a name, a description, an expected beginning and ending date, a priority, a list of order contacts to be notified by email at step completion, and a step-specific note to be passed on in that email notification.

Once an administrator has chosen to proceed with an order and initialized it, a main order details page may present a series of panels showing details for each services type. Additionally, it may expand the top panel to detail the order contacts, sequence, and new status.

Any individuals an administrator has chosen to keep “in the loop” for an order may appear as “Order Contacts” in an “Overview and Communication” panel. Based on the properties entered for each of the steps in the order sequence, different order contacts may receive email notifications at each step's completion. Additionally, every order contact may be notified by email when the order is completed, and each may add comments in the order messages discussion area. Administrators may also add, edit, and remove order contacts.

Order Sequence

For an order, an administrator may set up steps that may be “checked-off” upon completion so that all viewing the order may keep track of where the order is in its process. In an exemplary embodiment of the present invention, the five most current steps may appear in an “Overview and Communications” panel along with either the dates they are due (for future events) or the dates in which they were completed (for checked-off events). Events within two days of their due-date (including past-due events) may be highlighted.

Discussion Messages

Order contacts may add discussion messages to an order to keep each other (and all other potential viewers) informed as to the current status of the order. This may be useful, for example and not limitation, for carrier reps to convey that they need more information from an administrator to continue. The administrator could then post a message with the additional details.

Trouble Tickets

In an exemplary embodiment of the present invention, the system 200 may maintain a trouble ticketing system 215 for users to find resolution to problems with the organization's equipment and services. Typically, any user may submit a trouble ticket detailing his or her problems. Optionally, the user may choose, at the time of submission, a particular administrator to resolve the claim. The trouble ticketing unit 215 may be integrated into the system 200 to allow the user to better manage telecommunications resources. Alternatively, the system 200 may interface to external trouble ticketing software. In such an embodiment, the system 200 may load trouble ticket data from the external system. For example, and not limitation, the history that is collected in the integrated, or external, trouble ticketing unit 215 may be analyzed when renegotiating contract rates with carriers, or to provide backup for making claims regarding a carrier not meeting their service level agreements.

Filing a Trouble Ticket

To file an initial trouble ticket, a user may select the trouble ticket feature from a menu and enter a short description of the ticket (problem) to use as a ticket name (e.g. “Cell phone ringer broken”, etc.). Based on the importance, the user may choose a priority and a deadline. The user may also select an administrator to handle the trouble ticket. The user may also select the location to which the service/item belongs and enter a detailed description of the service or item and the trouble he or she is having.

In an exemplary embodiment of the present invention, when a trouble ticket is filed, an administrator will receive notice that a trouble ticket has been filed. As an administrator works to resolve the ticket, he or she may keep the ticket's status and details updated. Each time a change is made to the ticket (e.g. to note that more information is needed or to explain that a vendor is being contacted, etc.), the change may be noted as a new entry in the ticket, and an email notice may be distributed to the ticket filer.

Once a ticket has been “closed”, it may move to the “past trouble tickets” panel and may no longer be modifiable. It may, however, continue to be viewable.

Financial Management

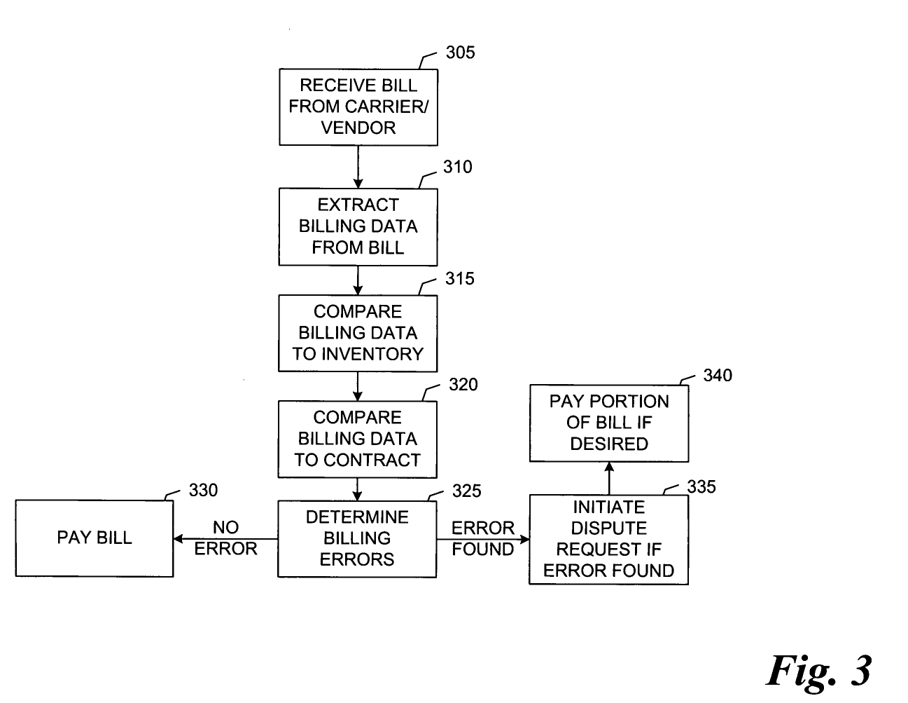

FIG. 3 is a flow diagram illustrating a bill payment procedure in accordance with an exemplary embodiment of the present invention. Every month an organization may receive up to hundreds or thousands of invoices covering scores of different accounts from various carriers and vendors (step 305). These invoices may come either on paper or electronically. Unfortunately, errors can and often do occur with telecom bills, and locating and resolving them is often an onerous task. Often companies prefer to pay mistaken charges rather than spend the time and expense poring over invoices in frequent audits.

Exemplary embodiments of the present invention may assist an organization to integrate billing with the inventory actually used or owned, and alert the organization to discrepancies as they appear. In an exemplary embodiment of the present invention, the system 200 may provide inventory account reconciliation, dispute tracking and resolution, and department/cost-center allocation. Such features may simplify telecom accounting processes and save money in erroneous charges. As with other sections of the system 200, the financial management functions may be integrated throughout inventory, contracts, and the order system 220.

Invoice Storage and Organization

Many of bills today arrive in an electronic format such as CD-ROM or other electronic file format. Such data may be incorporated into the system 200 through the billing unit 235 (step 310). The billing unit 235 may import billing data from bills into a database. The system 200 may also allow manual entry of any billing charges received in a standard paper form. The data may be stored for future analysis. The billing data may include, but is not limited to, vendor information, equipment identification, user identification, service period, itemized bill entries, and any other information associated with a bill.

When the billing data is extracted from the bills (step 310), it may be compared against inventory to assure that the equipment or service being billed is active in inventory (step 315). Paying bills for equipment that has been canceled is a common error and may cause significant losses for a company.

The billing data may also be compared against contract data for the associated equipment to assure that the bills are in accordance with the contract (step 320). The system 200 may identify that the company is being incorrectly charged. Such incorrect charges often occur when the vendor bills at a rate different from the agreed rate or charges additional charges that were not specified or allowed under the agreement.

By comparing the billing data against inventory (step 315) and the contracts (step 320), the system 200 may determine billing errors (step 325). If no error is found, the system 200 may initiate payment of the bill (step 330), or report to the user that the bill appears correct. If errors were found, the system 200 may initiate a dispute request (step 335) or report to the user that an error was found. When errors are identified, the user may chose to pay the entire bill and dispute the error or pay a portion of the bill (step 340), withholding the amount of the overcharge.

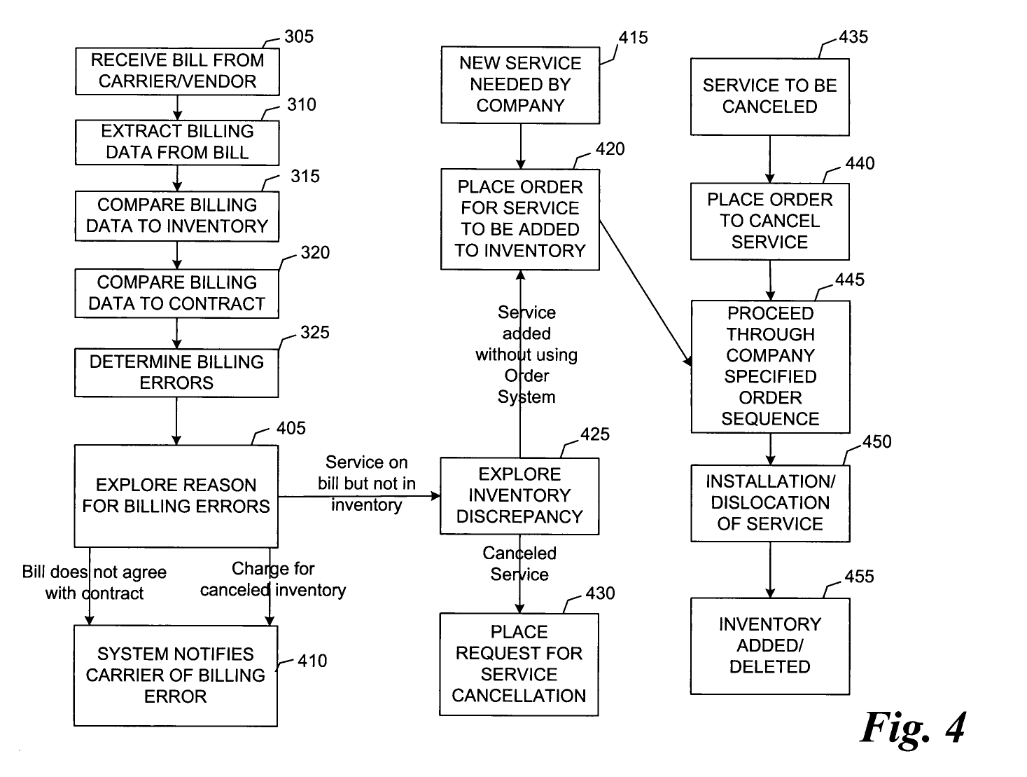

FIG. 4 is a flow diagram illustrating a service modification procedure in accordance with an exemplary embodiment of the present invention. When the system 200 identifies a billing error (step 325), it may identify the source of the error (step 405). If the billing data does not agree with the terms of the contract or if a charge is made for equipment or services that were cancelled, the system 200 may notify the vendor or carrier of the billing error (step 410). If the billing error involves a bill for service or equipment that is not in inventory, the system 200 may explore the inventory discrepancy (step 425). If a service was cancelled in inventory, but no request was made to the vendor, a request for service cancellation may be placed (step 430). If the service was added without using the service order/modification unit 220, the system 200 may add the service to inventory (step 420).

When new services or equipment are desired by a user (step 415), the user may initiate an order through the system 200 (step 420). Similarly, when a user wishes to cancel a service (step 435), the user may place an order to cancel the service (step 440). In both of these situations, the system 200 may proceed through a company specified order sequence (step 445). The company specified order sequence may be customized using the system 200, or a default order sequence may be used. Through the order sequence, a request may be sent to the vendor or carrier to install or dislocate a service (step 450). Upon acknowledgement from the vendor, or completion of the order, the system 200 may add or delete the equipment or service from inventory (step 455).

When it is time to pay an invoice, the system 200 may output a payable report using the reporting unit 225. The payable report may be a spreadsheet detailing carrier charges and short pays and may be sent to the company's accounts payables department. The reporting unit 225 may output invoice reports in other formats specified by a user.

The system 200 may receive invoices from a variety of billing entities and guide the user through them, from arrivals to alerts to disputes to resolutions to payables.

In an exemplary embodiment of the present invention, a billing procedure may include, but is not limited to, the following:

1. bills initialized

First-time invoices arrive in electronic format for automatic input or manual bills are entered, each organized by biller, bill name, and billing number.

2. accounts associated with inventory

Each account on a bill may be connected to a specific service, contract, and location in inventory.

3. new monthly invoices inputted for each bill

New invoices either arrive in electronic format for automatic input or charges from paper invoices are manually entered

4. alerts appear

Any invoices not yet marked as paid may be so noted. Alert icons may appear next to bills whose items or invoices have been previously disputed by you or that contain accounts not found in inventory (e.g. new or mistaken charges.)

5. disputes and resolutions

Until an individual invoice is paid, a user may flag disputes against charges of concern. The user may either opt to pay them in full but track them as problems or choose to “short-pay” them, withholding a part of the payment.

6. invoices paid and payables reports generated

Once disputes and short-pays have been filed, the user may choose to mark the invoice as paid and create a spreadsheet payables report (or custom format) that may be sent to accounts payable for payment.

Reporting

In an exemplary embodiment of the present invention, the system 200 may allow a user to create customized or standard reports for review. For example, and not limitation, aggregated reports may be created based on the inventory and financial data contained within the application. The system 200 may provide several standard reports and allow and user to create and save any number of custom reports by choosing variables as necessary.

Standard reports may provide oft-requested details pre-organized into logical formats. Standard reports may include, but are not limited to, ATM Services, BTN Lists, Calling Card Services, Contract Listing, DSL Services, Frame Services, Locations, Voice CPE, Data CPE, Toll Free Lines, Wireless Details, Local Lines, Users, or other desired standard reports.

In an exemplary embodiment of the present invention, the system 200 is operable to automatically process user requests independently. In such an embodiment, administrator interaction, and possibly administrator approval may be bypassed. The system 200 may contact outside vendors directly to place orders and automatically update the inventory tracking unit and the contract management unit regarding the new order. Typically, the system 200 will communicate with a vendor electronically to place orders. Furthermore, the system 200 may electronically receive invoices from a vendor. When the system 200 is electronically linked to vendors for both order processing and invoicing, the system 200 may operate with limited user interaction.

While the invention has been described in detail with particular reference to exemplary embodiments thereof, it will be understood that variations and modifications can be effected within the scope of the invention as defined in the appended claims.

What is claimed is:

1. A data processing system for managing resources comprising:
an inventory tracking unit adapted to maintain inventory data for a plurality of resources;
an inventory modification unit in communication with the inventory tracking unit and adapted to modify inventory data;
a contract management unit adapted to maintain contract data for one or more resource contracts, wherein each resource contract is associated with one or more of said plurality of resources;
a bill processing unit adapted to maintain billing data associated with each of said plurality of resources; and
a processing unit adapted to reconcile the billing data, contract data, and inventory data.

2. The system of claim 1, wherein the resources are telecommunications resources.

3. The system of claim 1, wherein the inventory modification unit is adapted to initiate orders for new resources and to update the inventory tracking unit with inventory data representative of the new resource.

4. The system of claim 1, wherein the inventory modification unit is adapted to modify inventory data for each of said plurality of resources.

5. The system of claim 1, wherein the inventory tracking unit is adapted to automatically update inventory data when new resources are ordered.

6. The system of claim 1, wherein the inventory tracking unit is adapted to automatically update inventory data when existing resources are cancelled.

7. The system of claim 1, wherein the processing unit is adapted to identify billing discrepancies between the billing data and the contract data.

8. The system of claim 1, further comprising:
a reporting unit adapted to generate reports.

9. The system of claim 8, wherein the reporting unit is adapted to generate billing disputes.

10. The system of claim 8, wherein the reporting unit is adapted to generate reports representative of bills approved for payment.

11. The system of claim 1, further comprising:
a trouble ticket unit adapted to resolve problems associated with resources and to store historical analytical data.

12. The system of claim 1, wherein the processor unit is further adapted to compare the billing data, contract data, and inventory data to confirm that the billing data corresponds to current inventory data and contract data.

13. A method for managing resources of an organization comprising the steps of:
maintaining inventory data representative of a plurality of resources;
modifying inventory data when one or more resources is modified;
maintaining contract data for one or more resource contracts, wherein each resource contract is associated with one or more of the plurality of resources;
maintaining billing data associated with each of the plurality of resources; and
reconciling the billing data, contract data, and inventory data.

14. The method of claim 13, wherein the resources are telecommunications resources.

15. The method of claim 13, wherein the step of modifying inventory data is further adapted to initiate orders for new resources and to update the inventory data with inventory data representative of the new resource.

16. The method of claim 13, wherein the step of modifying inventory data is further adapted to modify inventory data for each of said plurality of resources.

17. The method of claim 13, wherein the step of modifying inventory data is further adapted to automatically update inventory data when new resources are ordered.

18. The method of claim 13, wherein the step of modifying inventory data is further adapted to automatically update inventory data when existing resources are cancelled.

19. The method of claim 13, wherein the step of reconciling the billing data, contract data, and inventory data is further adapted to identify billing discrepancies between the billing data and the contract data.

20. The method of claim 13, further comprising:
generating billing dispute reports.

21. The method of claim 13, further comprising:
generating reports representative of bills approved for payment.

22. The method of claim 13, further comprising:
resolving problems associated with telecommunications resources.

23. The method of claim 13, wherein the step of reconciling the billing data, contract data, and inventory data is further adapted to compare the billing data, contract data, and inventory data to confirm that the billing data corresponds to current inventory data and contract data.

24. The method of claim 13, further comprising the step of canceling resources associated with an employee when the employee leaves the organization.

25. The method of claim 13, further comprising the step of adding resources associated with an employee when the employee joins the organization.
